(19) United States
(12) Patent Application Publication
(10) Pub. No.: US 2013/0220777 A1
(43) Pub. Date: Aug. 29, 2013

(54) CENTERLINE ADJUSTABLE WIDTH CONVEYOR SYSTEM AND METHOD

(71) Applicants: Kevin J. Mauger, North Wales, PA (US); Jason J. Link, Bethlehem, PA (US); Ronald C. Schwar, Allentown, PA (US)

(72) Inventors: Kevin J. Mauger, North Wales, PA (US); Jason J. Link, Bethlehem, PA (US); Ronald C. Schwar, Allentown, PA (US)

(73) Assignee: NCC AUTOMATED SYSTEMS, INC., Souderton, PA (US)

(21) Appl. No.: 13/406,063

(22) Filed: Feb. 27, 2012

(51) Int. Cl. B65G 15/20

(52) U.S. Cl. 198/817

(57) ABSTRACT

A centerline adjustable conveyor system and method may include a plurality of conveyor beams for conveying product within the system and an adjustor for controlling the outer width of the plurality of beams. The system and method may include a second adjustor that operates in conjunction with the adjustor for controlling the outer width of the plurality of beams. The system and method may also include an adjustor belt coupling the adjustor and the second adjustor that transfers activation of one of the adjustor and second adjustor to the other of the adjustors. The system and method may use an adjustor that is a trapezoidal lead screw. The adjustor may be a 5 mm per rev. pitched screw having opposite direction pitches emanating from the center of the screw and each opposite pitch of the adjustor may adjust one of the plurality of conveyor beams.

### FIELD OF INVENTION

The present invention relates to automated conveyor systems, and more specifically to automated conveyor systems having a centerline adjustable width conveyor.

### BACKGROUND

The automation industry has been growing and has begun to process more and more types of equipment in a wide variety of industries. As a result some of the long standing industry norms are beginning to become limitations. These limitations are with respect to new industries and new products that may be produced using the automation industry.

Specifically, the industry has long provided guide rails for conveyor technology. The limitations on the ability of the guide rails to adjust to products and industries has lead to innovation within the industry and shortcomings on the ability to manufacture, at least efficiently manufacture, certain products.

With the explosion in the solar industry and the growth of renewable energy sources in general, a need has been borne for enabling guide rails to support the in process solar panels, precisely move the in process solar panels, allow for bypassing of in process solar panels by other panels, adjusting the guide rails of the system, and adjusting the conveyor beams, such as for example, to maintain a fixed center line.

### SUMMARY

A centerline adjustable conveyor system and method is disclosed. The system and method may include a plurality of conveyor beams for conveying product within the system and an adjustor for controlling the outer width of the plurality of beams. The system and method may also include a frame, plurality of leveling feet and plurality of wheels for supporting the plurality of conveyor beams.

The system and method may include a second adjustor that operates in conjunction with the adjustor for controlling the outer width of the plurality of beams. The system and method may also include an adjustor belt coupling the adjustor and the second adjustor that transfers activation of one of the adjustor and second adjustor to the other of the adjustors.

The system and method may use an adjustor that is a trapezoidal lead screw. The adjustor may be a 5 mm per rev. pitched screw having opposite direction pitches emanating from the center of the screw and each opposite pitch of the adjustor may adjust one of the plurality of conveyor beams.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts:

FIG. 1 illustrates a centerline adjustable width conveyor system;

FIG. 2 illustrates a centerline adjustable width conveyor system;

FIG. 3 illustrates a bypass configured within the system of FIG. 1;

FIG. 4 illustrates a right angle transfer configured within the system of FIG. 1;

FIG. 5 illustrates a method of controlling the centerline of an automated conveyor system; and

FIG. 6 illustrates the system of FIG. 1 configured with a product.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in automated conveyor systems. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

The present invention is a centerline adjustable conveyor system and method. The system and method may include a plurality of conveyor beams for conveying product within the system and an adjustor for controlling the outer width of the plurality of beams. The system and method may also include a frame, plurality of leveling feet and plurality of wheels for supporting the plurality of conveyor beams.

The system and method may include a second adjustor that operates in conjunction with the adjustor for controlling the outer width of the plurality of beams. The system and method may also include an adjustor belt coupling the adjustor and the second adjustor that transfers activation of one of the adjustor and second adjustor to the other of the adjustors.

The system and method may use an adjustor that is a trapezoidal lead screw. The adjustor may be a 5 mm per rev. pitched screw having opposite direction pitches emanating from the center of the screw and each opposite pitch of the adjustor may adjust one of the plurality of conveyor beams.

Specifically, the present invention provides a centerline adjustable width conveyor where the conveyor beam (adjusts independent) of the rails to allow more precise handling and positioning. While the capability may provide adjustable guide rails, the centerline adjustable wide conveyor provides the needed functionality for controlling and processing a product, such as when the product is made of glass including a plurality of solar panels, for example.

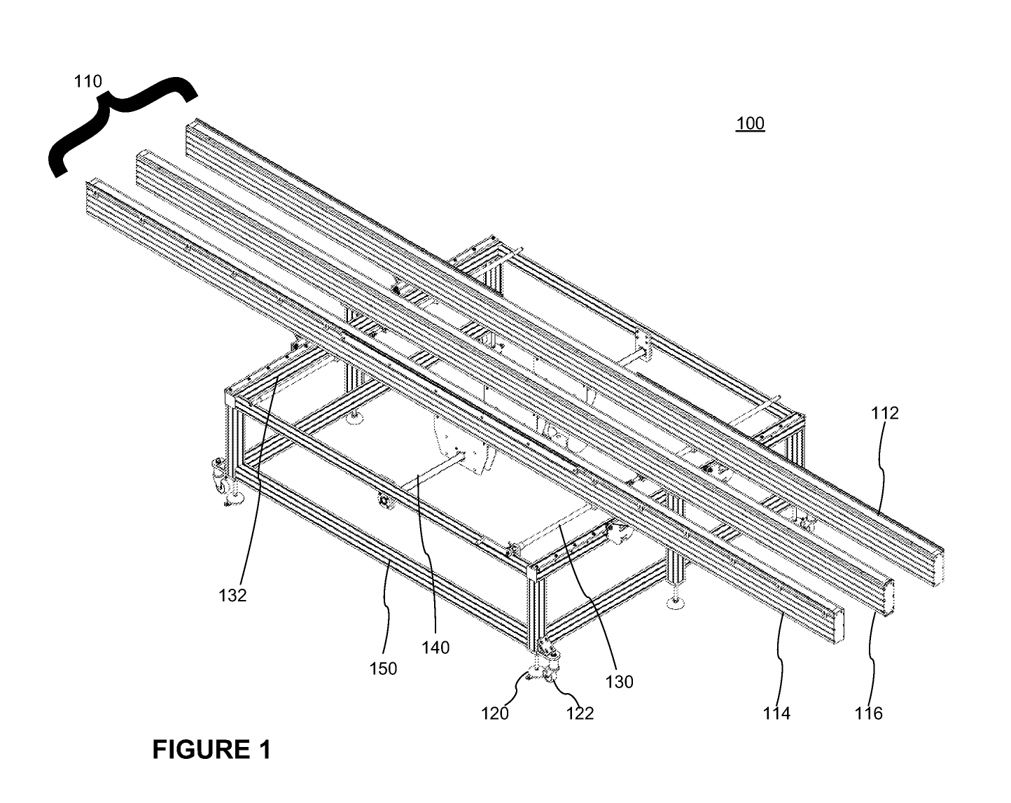

Referring now to FIG. 1, there is illustrated a centerline adjustable width conveyor system 100. System 100 may include a plurality of conveyor beams 110 for supporting and conveying a product. Conveyor beams 110 may include individual beams 112, 114, 116. Conveyor beam 116 is shown as the center conveyor beam. System 100 may also include a frame 150 supported by a plurality of leveling feet 120 (six shown in FIG. 1) and a plurality of wheels 122 (four shown in FIG. 1). Frame 150 may provide support for plurality of conveyor beams 110. Product may be conveyed along plurality of conveyors 110 by operation of drive shaft 140. As shaft 140 rotates a conveyor belt 160 located within each one of conveyors beams 110 is actuated and controls movement of a product within system 100.

Conveyor belt 160 may automatically adjust with conveyor beams 110 to which each drive belt is associated, as conveyor beams 110 are adjusted for width. That is, each conveyor belt 160 adjusts by expanding and contracting with the adjustments to each of conveyor beams 110. Conveyor belt 160 may be housed internal to each individual conveyor beam 110 and allow an approximately co-planar aspect between he top of beam 110 and the portion of belt 160 proximate thereto.

Each conveyor belt 160 may be singular or may include multiple belts. Each conveyor belt 160 may be or include a timing belt or other drive mechanism. Each belt may be configured two inches wide and may be made of Intralox 900 series, modular plastic belting with 0% open area, for example. Conveyor belt 160 may be grey acetyl belt with polypropylene rods. Conveyor belt 160 may be controlled by belt sprockets that are nylon with positive engagement.

First conveyor beam adjustor 130 and second conveyor beam adjustor 132 may be actuated to control the width of conveyor beams 110. In particular, actuation of one of belt 130, 132 may control the other of belt 132, 130, thereby controlling the location of beam 112 and bean 114 with respect to center beam 116. Each adjustor 130, 132 may be made from steel. For example, adjustors 130, 132 may take the form of a trapezoidal lead screw. Adjustors 130, 132 may be 5 mm per rev. pitched screws that have opposite direction pitches emanating from the center of the screw. This opposite pitched direction allows movement of the screw about the longitudinal axis to move each of conveyor beam 112, 114 inward (or outward), as opposed to the traditional way of moving them both in the same direction. Using a higher pitched screw may provide for more precise motions of beams 112, 114. This finer motion comes at the expense of greater turn of the screw to move beams 112, 114 a certain distance.

Adjustors 130, 132 may adjust conveyor beams 110 to convey products with widths ranging from 0.9 to 2.0 meters. Adjustors may provide adjustment of the centerline of system 100 with 1 mm control and accuracy. Since the entire conveyor beam 110 may adjust with sturdy fixed guide rail mounted securely to conveyor beams 110, guiding and significantly improved and more consistent than adjustable guide rails. This adjustment may be accomplished by V-guided rollers running on a linear rail and lead screw based adjustment.

Alternative methods of adjustment may also be used. For example, in systems with different requirements and/or simpler applications, the sliding mechanism and lead screw may be replaced with plastic “shoes” that act as bushings along the frame 150. The conveyor beam 110 may be mounted to a carriage (or carriages). The carriage may be lined with ultra-high-molecular-weight polyethylene (UHMW) that acts as a shoe to allow the beam to slide on the frame 150. To move the conveyor beam 110, an operator or mechanic would loosen some hardware on the relevant carriages, push the beam to the predetermined location, and lock it back in place with the hardware. This may provide a less precise and more manual adjust of the conveyor on the frame.

Frame 150 may be designed to handle up to 450 kg of panels. Frame 150 may be configured from extruded aluminum shapes. Frame 150 may be made from 6063 T6 anodized aluminum beams and may be 80 by 200 mm. Frame 150 and beams 110 may be designed in 8 mm T-slots to provide modular bulk construction.

System 100 may be designed with beam lengths (frame and conveyor) up to 20 feet long. Additional length of beams may be aggregated together to increase the length of system 100 by slicing as needed. The modular design and ability to splice lengths of system 100 together creates an unlimited operable length. Splice plates may be used to join 20 foot beams to create longer sections and may include stabilizers to secure longer beams from movement. System 100 may be built to any height.

Plurality of leveling feet 120 may support system 100. Leveling feet 120 may allow height adjustment from 925 mm to 1054 mm (36 7/16 to 41½ inches). Plurality of wheels 122 may be included to allow for easy installation and improved mobility, for example.

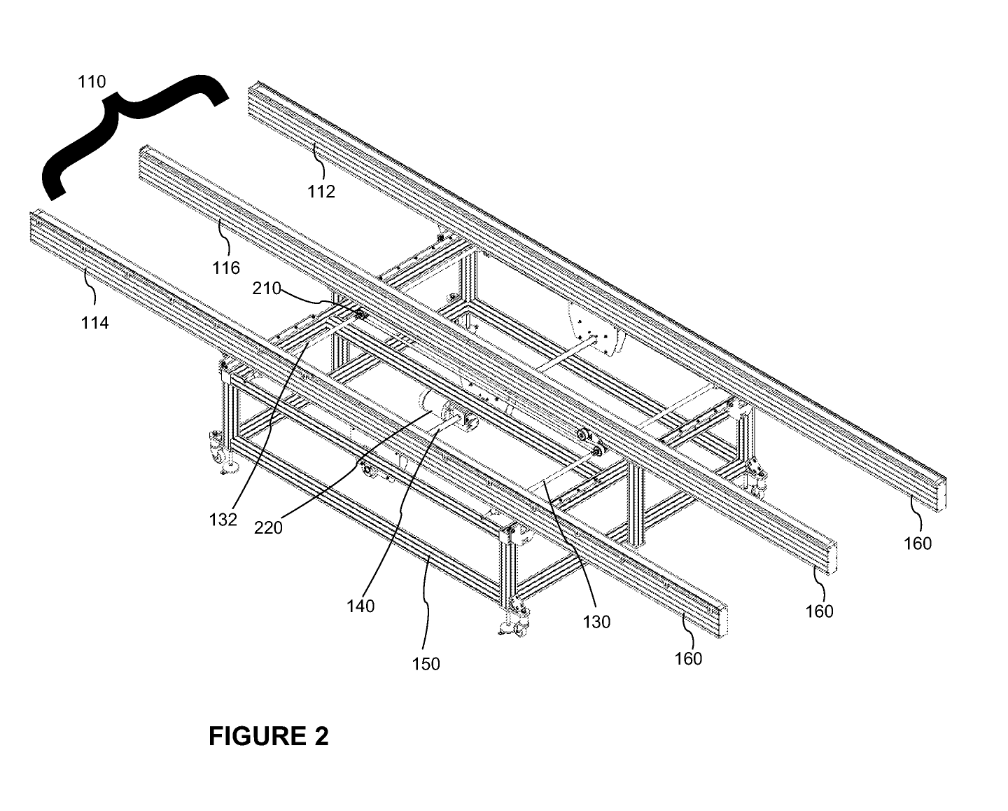

Referring now also to FIG. 2, there is illustrated centerline adjustable width conveyor system 100. Plurality of conveyor beams 110 may have been actuated, as compared to those shown in FIG. 1, to handle a wider product. Edge conveyor beams 112, 114 a shown spaced further from center conveyor beam 116.

Adjustor belt 210 to actuate each of first conveyor beam adjuster 130 and second conveyor beam adjuster 132. Adjustor belt 210 may provide movement of outer conveyor beams 112, 114 in a parallel fashion to maintain proper movement of product along plurality of conveyor beams 110.

Adjustor belt 210 may provide for actuation of width adjustment at any point along conveyor beam adjuster 130, 132. For example, an end of conveyor beam adjuster 130 may be actuated to reduce the overall width of plurality of conveyor beams 110. Adjustor belt 210 may couple actuation of conveyor beam adjuster 130 to conveyor beam adjustor 132. This actuation of each conveyor beam adjuster 130, 132 may move each of conveyor beams 112, 114 in a parallel fashion. The actuation of one of conveyor beam 112, 114 with the coupling of adjustor belt 210 may provide precise adjustments.

The adjustor belt 210 coupled to conveyor beams adjuster 130, 132 may be actuated with an adjustment crank (not shown). The adjustment crank may be located at different locations around system 100. For example, the adjustment crank may be located at either end of either conveyor beam adjuster 130, 132.

Shaft 140 may allow a mechanical coupling of motor 220 to each of conveyor belt 160 adapted with each of plurality of conveyor beams 110, such as by coupling the drive of motor 220 to each conveyor belt 160. This conveys product in system 100. Independent drives may be provided. That is, a motor may be provided to drive each conveyor belt 160 independently. Such a configuration may eliminate the use of shaft 140.

Motor 220 may allows conveyor to be operated in either direction. Motor 220 may be mounted on center conveyor beam 116. This type of mounting may provide for easy access. Motor 220 may be any type of drive motor. For example, a motor providing 240/460 VAC 60 Hz or 190/380VAC 50 Hz, three-phase, and medium duty with a 10:1 ratio may be used. Alternatively, a DC low-voltage motor may be used. Such a DC motor may provide benefits when configured to drive each conveyor belt 160 independently. This configuration may require a separate DC motor for each of beams 110, for example.

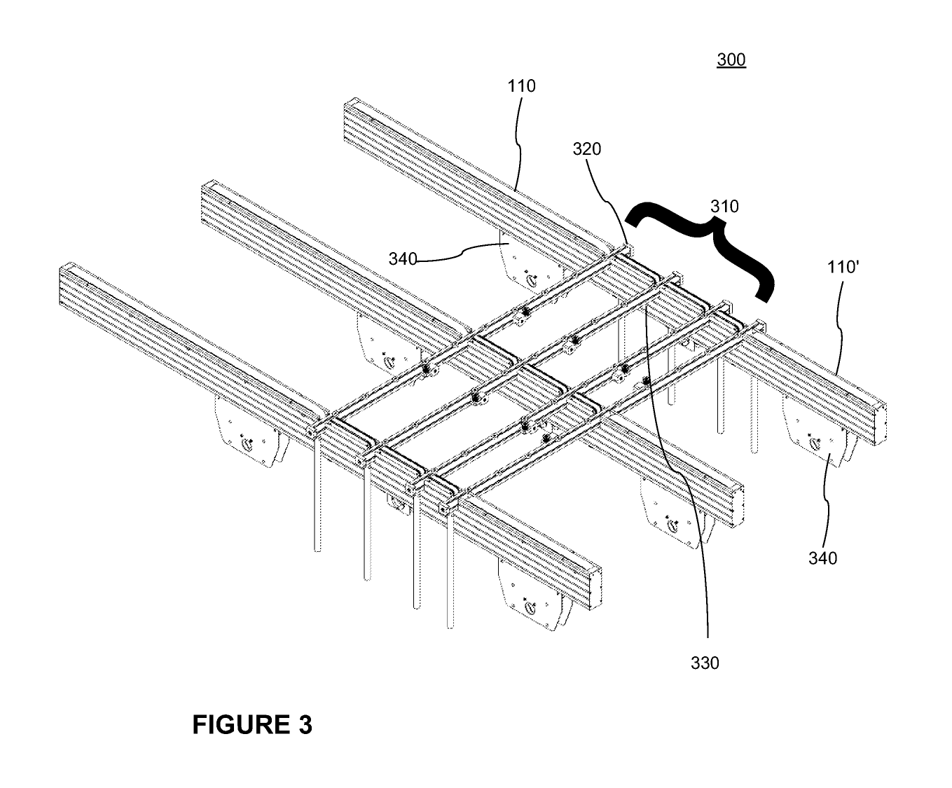

Referring now to FIG. 3, there is illustrated a bypass system 300 that may be configured within system 100. Bypass system 300 may allow a product to pass by a product that is being worked on. For example, a glass panel may pass underneath another glass panel while processing continues on the panel above. Bypass system 300 may allow for equipment in a straight line to function as a parallel operation and increase machine efficiency. The lift for bypass system 300 may be independent of the conveyor of system 100. Such a lift may be assembled to provide for heavy and/or precise lifting.

As shown in FIG. 3, bypass system 300 may include a bypass 310 operatively coupled between one or more conveyor beams 110 forming one or more zone (a conveyor beam 110 on each side of bypass 310 forms a zone operatively coupled to a bypass operatively coupled to another zone) Bypass 310 may include a lift 320. Lift 320 may be independent of the conveyor 100 allowing for a product to pass by a product that is being worked on. Lift 320 may operate independent of system 100 and may raise or lower bypass 310. Bypass system 300 may include a bypass drive 330 to enable movement of product along bypass 310. This movement may occur when the product is lifted or lowered by lift 320, or may occur when bypass 310 is aligned with conveyor(s) 110. Bypass 310 may be operatively coupled to conveyor 110 and conveyor 110 may be driven by a drive 340 that operates with shaft 140, motor 220, and adjustor belt 210 as described herein.

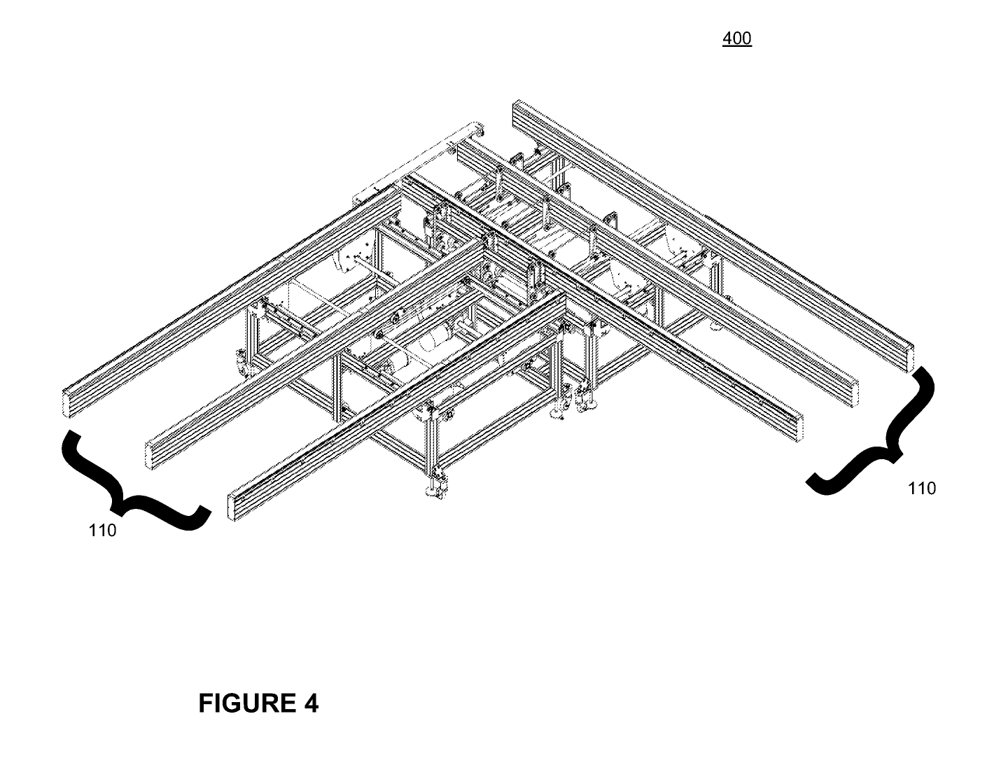

Referring now also to FIG. 4, there is illustrated a right angle transfer 400 that may be configured within system 100. Right angle transfer 400 may provide control of system 100 to maximize floor layout. Right angle transfer 400 may include a first configuration of system 100 and a second configuration of system 100. Conveyor beams from the first configuration may be configured adjacent to conveyor beams from the second configuration. Actuation of the conveyor beams from the first configuration may be oriented 90° to the actuation of the conveyor beams from the second configuration. In such a configuration a product being actuated by the first configuration may be placed on the conveyor beams form the second configuration, and thereby enabled to be actuated 90° from the first configuration actuation. A lift zone may be installed to provide a smooth transition during a right angle transfer.

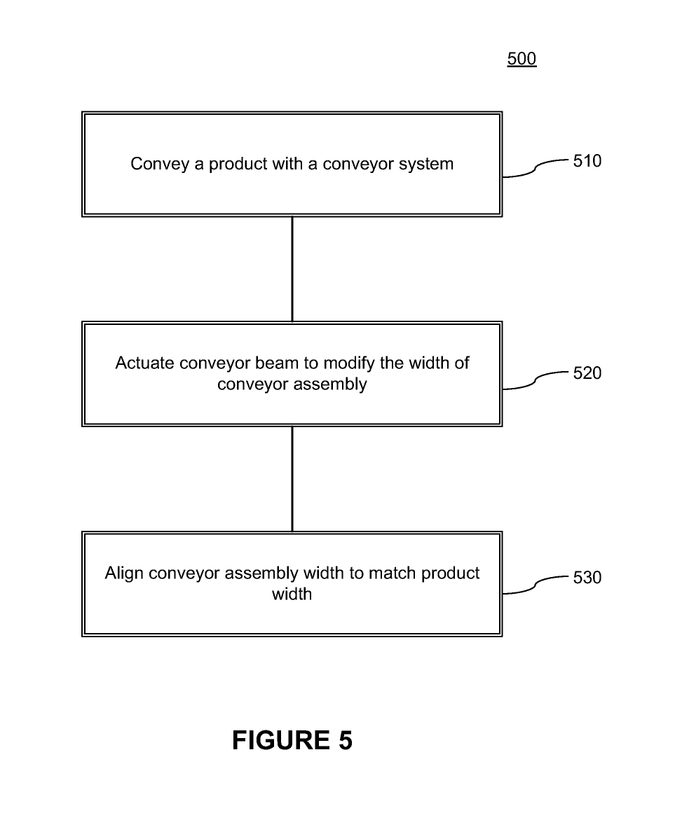

A method of controlling the centerline of an automated process is shown in FIG. 5. Specifically, FIG. 5 illustrates a method 500 for adjusting the centerline width of a conveyor system. Method 500 may include conveying a product within the conveyor system at step 510. Method 500 may include actuating conveyor beam to modify the width of conveyor assembly at step 520. Method 500 may include aligning conveyor assembly width to match product width at step 530.

Actuating conveyor beam to modify the width of conveyor assembly at step 520 may include adjusting conveyor belt by expanding and contracting with the adjustments to each of conveyor beams. This actuation may include a first conveyor beam adjustor and second conveyor beam adjustor that may be actuated to control the width of conveyor beams. In particular, actuation of one of one adjustor may control the other adjustor, thereby controlling the location of beam and beam with respect to center beam. An adjustor belt may be used to actuate each first conveyor beam adjuster and second conveyor beam adjuster. Adjustor belt may provide movement of outer conveyor beams in a parallel fashion to maintain proper movement of product along plurality of conveyor beams.

Adjustor belt may provide for actuation of width adjustment at any point along either conveyor beam adjuster. For example, an end of conveyor beam adjuster may be actuated to reduce the overall width of plurality of conveyor beams. Adjustor belt may couple actuation of conveyor beam adjuster to the other conveyor beam adjustor. This actuation of each conveyor beam adjuster may move each of conveyor beams in a parallel fashion. The actuation of one of the conveyor beam with the coupling of adjustor belt may provide precise adjustments.

The adjustor belt coupled to conveyor beams adjuster may be actuated with an adjustment crank. The adjustment crank may be located at different locations around the conveyor system. For example, the adjustment crank may be located at either end of either conveyor beam adjuster.

Aligning conveyor assembly width to match product width at step 530 may include the use of a digital indicator coupled with a crank handle (not shown).

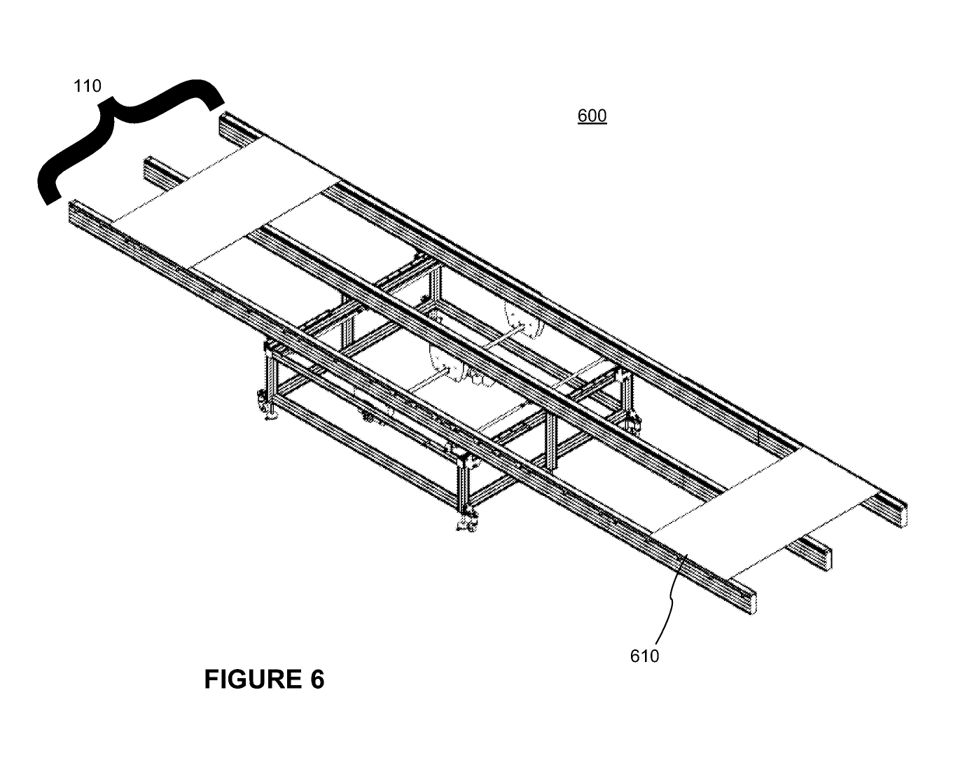

FIG. 6 illustrates system 100 configured with a product. Product 610 may be conveyed by conveyor beams 110.

System 100 may provide for basic applications, such as layup, bussing, machine infeeds, machine discharges, general transport, and accumulation. System 100 may accept product for infeed conveyors using pop-up transfer. System 100 may discharge product in two directions. When configured with three conveyor zones on a common frame, there is a single buffer zone for each direction. Pop-up transfers may be slave driven and provide smooth transfers while minimizing the number of motors.

Conveyor beams 110 may include buffer zones, such as multiple zones in a single beam. Such a configuration may allow for additional products to be loaded in a joint workflow configuration. Specifically, conveyor beams 110 may be configured with tri-zones that each operate independently.

In one embodiment, the guide rails may remain fixed, as movement is redundant since outer beams adjust as described. Fixing the guide rails and providing adjustment primarily or only using the conveyor beams may provide pinpoint accuracy such as is necessary when moving glass panels. Alternatively, the guide rails may also move.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

What is claimed is:

1. A centerline adjustable conveyor system, said system comprising:
a plurality of conveyor beams for conveying product within the system; and
an adjustor for controlling the outer width of said plurality of beams;

2. The system of claim 1, wherein said plurality of conveyor beams are supported by a frame.

3. The system of claim 2, wherein said frame is supported by a plurality of leveling feet.

4. The system of claim 2, wherein said frame is supported by a plurality of wheels.

5. The system of claim 1, further comprising a second adjustor that operate in conjunction with said adjustor for controlling the outer width of said plurality of beams.

6. The system of claim 5, further comprising an adjustor belt coupling said adjustor and said second adjustor that transfers activation of one of said adjustor and second adjustor to the other of said adjustors.

7. The system claim 1, wherein said adjustor is activated by at least one actuator.

8. The system of claim 1, wherein said adjustor is activated by at least one crank.

9. The system of claim 1, wherein said plurality of conveyor beams comprises a first, second and center conveyor beam.

10. The system of claim 9, wherein activation of said adjustor adjusts both the first and second conveyor beams toward the center beam, thereby decreasing the overall width of said plurality of conveyor beams.

11. The system of claim 9, wherein activation of said adjustor adjusts both the first and second conveyor beams away from the center beam, thereby increasing the overall width of said plurality of conveyor beams.

12. The system of claim 1, further comprising a right angle transfer coupled to said plurality of conveyor beams.

13. The system of claim 1, further comprising a bypass coupled to said plurality of conveyor beams.

14. The system of claim 1, further comprising a plurality of conveyor belts located proximate to each of said plurality of conveyor beams, said plurality of conveyor belts conveying the product within the system.

15. The system of claim 14, further comprising at least one motor for driving said plurality of conveyor belts.

16. The system of claim 15, further comprising a shaft for coupling the drive of said motor to at least one of said plurality of conveyor belts.

17. The system of claim 1, where said adjustor is a trapezoidal lead screw.

18. The system of claim 1, wherein said adjustor is a 5 mm per rev. pitched screw having opposite direction pitches emanating from the center of the screw.

19. The system of claim 18, wherein each opposite pitch of said adjustor adjusts one of said plurality of conveyor beams.

20. A method for adjusting the width of a conveyor system; said method comprising:
initiating movement of at least one of a plurality of conveyor beams to dimension the overall width of the plurality of conveyor beams commensurate with a product of the conveyor system.

21. The method of claim 20, wherein said initiating is activated by at least one actuator.

22. The method of claim 20, wherein said initiating is activated by at least one crank.

23. The method of claim 20, wherein said plurality of conveyor beams comprises a first, second and center conveyor beam.

24. The method of claim 23, wherein said initiating adjusts both the first and second conveyor beams toward the center beam, thereby decreasing the overall width of said plurality of conveyor beams.

25. The method of claim 23, wherein said initiating adjusts both the first and second conveyor beams away from the center beam, thereby increasing the overall width of said plurality of conveyor beams.

26. The method of claim 20, where said initiating comprises a digital indicator and a crank handle.

27. The method of claim 20, wherein said initiating comprises a 5 mm per rev. pitched screw having opposite direction pitches emanating from the center of the screw.

28. The method of claim 27, wherein each opposite pitch of the screw adjusts one of said plurality of conveyor beams.
